(19) United States
(12) Patent Application Publication
(10) Pub. No.: US 2022/0203776 A1
(43) Pub. Date: Jun. 30, 2022

(54) PNEUMATIC TIRE

(71) Applicant: The Yokohama Rubber Co., LTD., Tokyo (JP)

(72) Inventor: Masatoshi KURIYAMA, Kanagawa (JP)

(21) Appl. No.: 17/593,648

(22) PCT Filed: Mar. 27, 2020
(86) PCT No.: PCT/JP2020/014411

§ 371 Date: Sep. 22, 2021

(30) Foreign Application Priority Data
Mar. 28, 2019 (JP) 2019-064925

(51) Int. Cl. B60C 11/12; B60C 11/11; B60C 11/13

(52) U.S. Cl. CPC B60C 11/1204; B60C 11/11; B60C 2011/0355; B60C 2011/1209; B60C 11/1392

(57) ABSTRACT

A pneumatic tire includes a circumferential main groove extending in a tire circumferential direction, a block, which is a land portion defined by the circumferential main groove, a sipe extending through the block in a tire width direction, and a chamfered portion provided in the sipe. The length of the chamfered portion in the tire width direction is less than 70% of the sipe in the tire width direction.

### TECHNICAL FIELD

The present technology relates to a pneumatic tire.

### BACKGROUND ART

In recent pneumatic tires, sipes may be provided in a tread portion in order to ensure water drainage properties. Additionally, notched sipes provided with a notch portion in a wall surface of the sipe may be provided in the tread portion. A known example of a conventional pneumatic tire that is configured in this manner is the technology described in Japan Unexamined Patent Publication No. 2014-237398.

However, with the known pneumatic tire described above, there is room for improvement in wear resistance performance, dry braking performance, and wet braking performance.

### SUMMARY

The technology provides a pneumatic tire with improved wear resistance performance, dry braking performance, and wet braking performance.

A pneumatic tire from an aspect of the present technology includes a circumferential main groove extending in a tire circumferential direction, a land portion defined by the circumferential main groove, a sipe extending through the land portion in a tire width direction, and a chamfered portion provided in the sipe, a length of the chamfered portion in the tire width direction being less than 70% of a length of the sipe in the tire width direction.

Preferably, the length of the chamfered portion 8 in the tire width direction is 20% or more of the length of the sipe in the tire width direction.

Preferably, when a groove depth of the circumferential main groove is D, a depth of the sipe is Ds, and a depth of the chamfered portion is Dm, a relationship between depths is D>Ds>Dm.

Preferably, when a width of the chamfered portion in a direction orthogonal to an extension direction of the sipe in a road contact surface of the land portion is ML, a relationship between ML and the depth Dm of the chamfered portion is ML>Dm.

The chamfered portion may be provided on at least one of groove wall surfaces of the sipe.

The pneumatic tire according to the present technology can improve wear resistance performance, dry braking performance, and wet braking performance.

### BRIEF DESCRIPTION OF DRAWINGS

FIG. 1 is a cross-sectional view in a tire meridian direction illustrating a pneumatic tire according to an embodiment of the technology.

FIG. 2 is a plan view illustrating a tread surface of the pneumatic tire illustrated in FIG. 1.

FIG. 3 is an enlarged view illustrating a first example of a block illustrated in FIG. 2.

FIG. 4 is a cross-sectional view along line A-A in FIG. 3.

FIG. 5 is an enlarged view illustrating a second example of the block illustrated in FIG. 2.

FIG. 6 is an enlarged view illustrating a third example of the block illustrated in FIG. 2.

FIG. 7 is an enlarged view illustrating a fourth example of the block illustrated in FIG. 2.

FIG. 8 is an enlarged view illustrating a fifth example of the block illustrated in FIG. 2.

FIG. 9 is an enlarged view illustrating a sixth example of the block illustrated in FIG. 2.

FIG. 10 is a cross-sectional view along line A-A in FIG. 9.

### DETAILED DESCRIPTION

Embodiments of the present technology are described in detail below with reference to the drawings. In the embodiments described below, identical or substantially similar components to those of other embodiments have identical reference signs, and descriptions of those components are either simplified or omitted. The present technology is not limited by the embodiments. Constituents of the embodiments include elements that are substantially identical or that can be substituted and easily conceived by one skilled in the art. Furthermore, the plurality of modified examples described in the embodiments can be combined as desired within the scope apparent to one skilled in the art.

### Pneumatic Tire

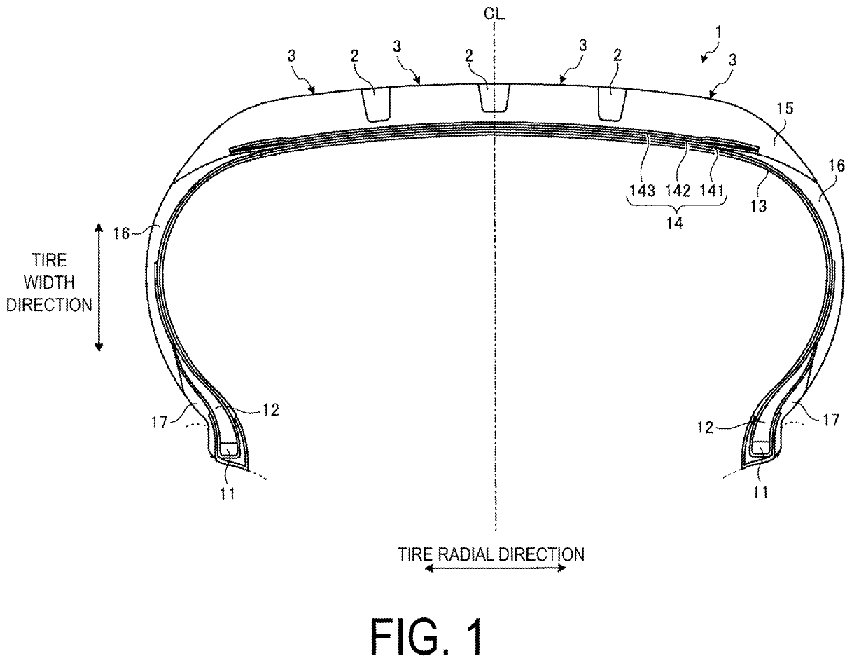

FIG. 1 is a cross-sectional view in a tire meridian direction illustrating a pneumatic tire according to an embodiment of the technology. FIG. 1 is a cross-sectional view of a half region in a tire radial direction. FIG. 1 illustrates a studless tire for a passenger vehicle as an example of the pneumatic tire.

In FIG. 1, “cross section in a tire meridian direction” refers to a cross section of the tire taken along a plane that includes a tire rotation axis (not illustrated). A reference sign CL denotes a tire equatorial plane and refers to a plane perpendicular to the tire rotation axis that passes through the center point of the tire in a tire rotation axis direction. “Tire width direction” refers to the direction parallel with the tire rotation axis. “Tire radial direction” refers to the direction perpendicular to the tire rotation axis.

A pneumatic tire 1 has an annular structure with the tire rotation axis as its center and includes: a pair of bead cores 11, 11, a pair of bead fillers 12, 12, a carcass layer 13, a belt layer 14, a tread rubber 15, a pair of sidewall rubbers 16, 16, and a pair of rim cushion rubbers 17, 17 (see FIG. 1).

The pair of bead cores 11, 11 have an annular structure formed by winding one or a plurality of bead wires made of steel multiple times and are embedded in bead portions to constitute cores of the left and right bead portions. The pair of bead fillers 12, 12 are disposed on an outer circumference of the pair of bead cores 11, 11 in the tire radial direction and constitute the bead portions.

The carcass layer 13 has a single layer structure made of one carcass ply or a multilayer structure made of a plurality of carcass plies, and extends between the left and right bead cores 11, 11 in a toroidal shape, forming the backbone of the tire. Additionally, both end portions of the carcass layer 13 are wound and turned back toward an outer side in the tire width direction so as to wrap the bead cores 11 and the bead fillers 12 and fixed. The carcass ply (plies) of the carcass layer 13 is made by performing a rolling process on a plurality of coating rubber-covered carcass cords made of steel or an organic fiber material (e.g. aramid, nylon, polyester, rayon, or the like). The carcass ply (plies) has a carcass angle (defined as the inclination angle in the longitudinal direction of the carcass cords with respect to the tire circumferential direction), as an absolute value, of 80 degrees or more and 95 degrees or less.

The belt layer 14 is a multilayer structure including a pair of cross belts 141, 142 and a belt cover 143 and is disposed to wind around the outer circumference of the carcass layer 13. The pair of cross belts 141, 142 is made by performing a rolling process on coating rubber-covered belt cords made of steel or an organic fiber material. The cross belts 141, 142 have a belt angle, as an absolute value, of 20 degrees or more and 55 degrees or less. Furthermore, the pair of cross belts 141, 142 have belt angles (defined as the inclination angle in the longitudinal direction of the belt cords with respect to the tire circumferential direction) of mutually opposite signs and are layered so that the longitudinal directions of the belt cords intersect each other (a so-called crossply structure). Additionally, the belt cover 143 is made by covering belt cords made of steel or an organic fiber material with a coating rubber. The belt cover 143 has a belt angle, as an absolute value, of 0 degrees or more and 10 degrees or less. Further, the belt cover 143 is, for example, a strip material formed by covering one or more belt cords with a coating rubber and winding the strip material spirally around the outer circumferential surface of the cross belts 141, 142 multiple times in the tire circumferential direction.

The tread rubber 15 is disposed on the outer circumference of the carcass layer 13 and the belt layer 14 in the tire radial direction and constitutes a tread portion of the tire. The pair of sidewall rubbers 16, 16 are disposed on the outer side in the tire width direction of the carcass layer 13 and constitute left and right sidewall portions. The pair of rim cushion rubbers 17, 17 are disposed on an inner side in the tire radial direction of the turned back portions of the carcass layer 13 and the left and right bead cores 11, 11 to form a rim-fitting surface of the bead portion.

### Tread Pattern

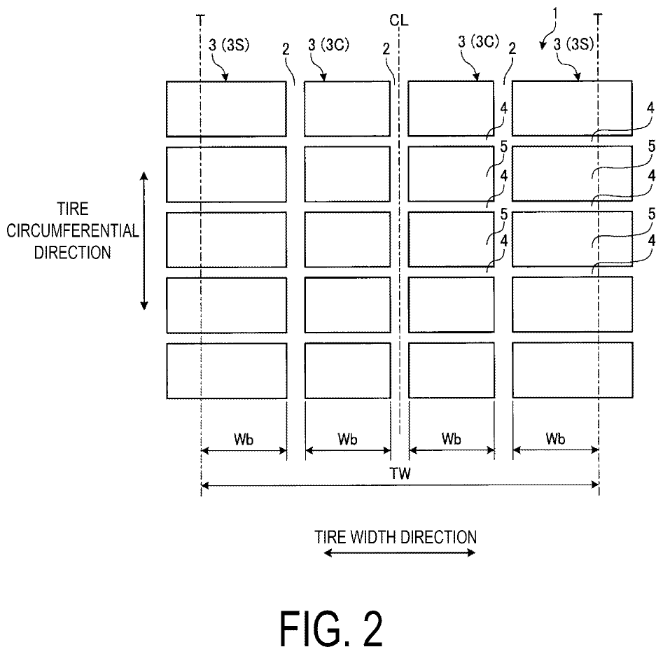

FIG. 2 is a plan view illustrating a tread surface of the pneumatic tire illustrated in FIG. 1. FIG. 2 illustrates a typical block pattern. In FIG. 2, “tire circumferential direction” refers to the direction revolving about the tire rotation axis. Reference sign T denotes a tire ground contact edge, and a dimension symbol TW denotes a tire ground contact width.

As illustrated in FIG. 2, the pneumatic tire 1 is provided with, in the tread surface, a plurality of circumferential main grooves 2 extending in the tire circumferential direction, a plurality of land portions 3 defined by the circumferential main grooves 2, and a plurality of lug grooves 4 disposed in the land portions 3. Of the plurality of land portions 3, the land portions 3 near the tire equatorial plane CL are center land portions 3C. The land portions 3 on the outer side in the tire width direction of the center land portions 3C are shoulder land portions 3S.

“Main groove” refers to a groove on which a wear indicator must be provided as specified by JATMA (The Japan Automobile Tyre Manufacturers Association, Inc.) and has a groove width of 3.0 mm or more and a groove depth of 5.0 mm or more. “Lug groove” refers to a lateral groove extending in a tire width direction, has a groove width of 1.0 mm or more and a groove depth of 3.0 mm or more, and opens when the tire comes into contact with the ground to function as a groove.

The groove width is the maximum distance between left and right groove walls at the groove opening portion and is measured when the tire is mounted on a specified rim, inflated to the specified internal pressure, and in an unloaded state. In a configuration in which the land portion includes a notch portion or a chamfered portion on an edge portion thereof, the groove width is measured with intersection points between the tread contact surface and extension lines of the groove walls as measurement points, in a cross-sectional view with the groove length direction as a normal line direction. In a configuration in which the grooves extend in a zigzag shape or a wave shape in the tire circumferential direction, the groove width is measured with reference to the center line of the oscillation of the groove walls as measurement points.

The groove depth is the maximum distance from the tread contact surface to the groove bottom and is measured when the tire is mounted on a specified rim, inflated to the specified internal pressure, and in an unloaded state. Additionally, in a configuration in which the grooves include a partially uneven portion or sipe on the groove bottom, the groove depth is measured excluding these portions.

“Specified rim” refers to an “applicable rim” defined by the Japan Automobile Tyre Manufacturers Association Inc. (JATMA), a “Design Rim” defined by the Tire and Rim Association, Inc. (TRA), or a “Measuring Rim” defined by the European Tyre and Rim Technical Organisation (ETRTO). Additionally, “specified internal pressure” refers to a “maximum air pressure” defined by JATMA, to the maximum value in “TIRE LOAD LIMITS AT VARIOUS COLD INFLATION PRESSURES” defined by TRA, or to “INFLATION PRESSURES” defined by ETRTO. Additionally, “specified load” refers to a “maximum load capacity” defined by JATMA, the maximum value in “TIRE LOAD LIMITS AT VARIOUS COLD INFLATION PRESSURES” defined by TRA, or “LOAD CAPACITY” defined by ETRTO. However, in the case of JATMA, for a tire for a passenger vehicle, the specified internal pressure is an air pressure of 180 kPa, and the specified load is 88% of the maximum load capacity.

Among the two or more circumferential main grooves (including the circumferential main grooves disposed on the tire equatorial plane CL) disposed in one region demarcated by the tire equatorial plane CL, a circumferential main groove located on the outermost side in the tire width direction is defined as an outermost circumferential main groove. The outermost circumferential main groove is defined in each of the left and right regions demarcated by the tire equatorial plane CL. The distance from the tire equatorial plane CL to the outermost circumferential main grooves (dimension symbol omitted in the drawing) is in a range of 20% or more and 35% or less of the tire ground contact width TW.

The tire ground contact width TW is measured as the maximum linear distance in the tire axial direction of a contact surface between the tire and a flat plate when the tire is mounted on a specified rim, inflated to a specified internal pressure, placed perpendicular to the flat plate in a static state, and loaded with a load corresponding to a specified load.

The tire ground contact edge T is defined as a maximum width position in the tire axial direction of the contact surface between the tire and a flat plate when the tire is mounted on a specified rim, inflated to a specified internal pressure, placed perpendicular to the flat plate in a static state, and loaded with a load corresponding to a specified load.

The land portions 3 located on the outer side in the tire width direction that are defined by the outermost circumferential main grooves 2 are defined as shoulder land portions. The shoulder land portions 3 are land portions located on the outermost side in the tire width direction and on the tire ground contact edge T.

Additionally, in the configuration of FIG. 2, each of the land portions 3 includes a plurality of lug grooves 4. The lug grooves 4 have an open structure that extends through the land portions 3 and are disposed at predetermined intervals in the tire circumferential direction. As a result, all of the land portions 3 are divided in the tire circumferential direction by the lug grooves 4 to form a block row composed of a plurality of blocks 5. However, no such limitation is intended, and for example, the land portions 3 may be ribs that are continuous in the tire circumferential direction (not illustrated).

The ground contact width Wb of each block 5 is measured as the maximum linear distance in the tire axial direction on a contact surface between the block and a flat plate when the tire is mounted on a specified rim, inflated to the specified internal pressure, placed perpendicular to the flat plate in a static state, and loaded with a load corresponding to the specified load.

In the configuration of FIG. 2, the circumferential main grooves 2 and the lug grooves 4 are disposed in a lattice-like form to form rectangular blocks 5. However, the blocks 5 may have any shape. For example, the circumferential main grooves 2 may have a zigzag shape having amplitudes in the tire width direction, or the lug grooves 4 may be bent or curved (not illustrated). Additionally, for example, the pneumatic tire 1 may include, instead of the circumferential main grooves 2 and the lug grooves 4 in FIG. 2, a plurality of inclined main grooves that extend while inclining at a predetermined angle with respect to the tire circumferential direction, lug grooves that communicate adjacent inclined main grooves with each other, and a plurality of blocks defined by the inclined main grooves and the lug grooves (not illustrated). In these configurations, the blocks can have elongated and complex shapes.

Also, although not illustrated in FIG. 2, each block 5 includes a sipe and a chamfered portion formed in the sipe, as described below.

### Sipe and Chamfered Portion of Sipe

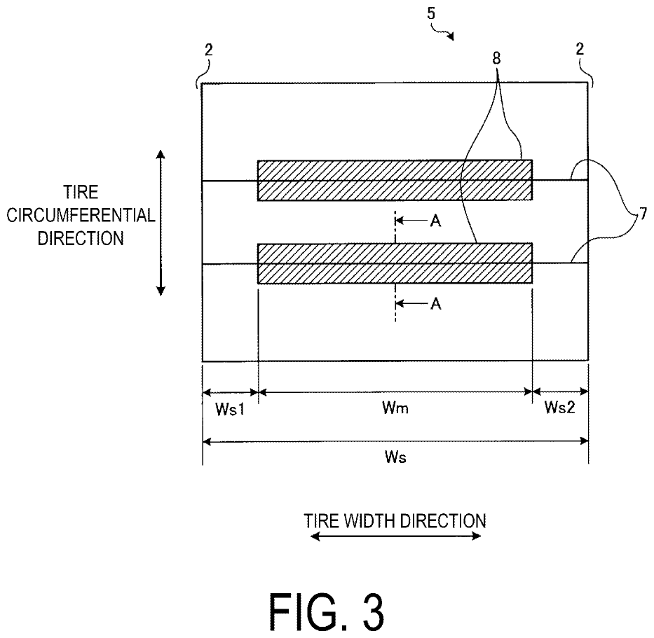

FIG. 3 is an enlarged view illustrating a first example of the block illustrated in FIG. 2. FIG. 3 is a plan view of one block 5 located in the center land portion 3C.

As illustrated in FIG. 3, the block 5 includes a plurality of sipes 7 and a chamfered portion 8 provided in each of the sipes 7. The sipe 7 and the chamfered portions 8 are disposed in a row. The sipe 7 is a notch formed in the tread contact surface, and has a groove width of 0.4 mm or more and 1.0 mm or less and a groove depth of 4 mm or more and 32 mm or less. The sipe 7 is closed in a case where the tire contacts the ground.

The sipe 7 extends in the tire width direction through the block 5, that is, through the land portion (see FIG. 2). In the portion where the sipe 7 is disposed, the sipe 7 has a length of 100% with respect to the length in the tire width direction. When the block 5 is rectangular, the sipe 7 has a length of 100% with respect to the minimum length of the block 5 in the tire width direction. When the block 5 is rectangular, the sipe 7 has a length of 100% with respect to the maximum length of the block 5 in the tire width direction. The sipe 7 divides the blocks 5 in the portion where the sipe 7 is provided. When the block 5 is rectangular, since the minimum length and the maximum length of the block 5 in the tire width direction coincide with the ground contact width Wb, the sipe 7 has a length of 100% with respect to the ground contact width Wb.

FIG. 3 illustrates a case where two sipes 7 are provided in the block 5 that is defined by a pair of circumferential main grooves 2 and the lug grooves. The number of sipes 7 is not limited to two, and more sipes 7 may be provided.

In FIG. 3, one chamfered portion 8 is provided in the sipe 7 in the present example. The chamfered portion 8 is a portion that connects edge portions of adjacent surfaces to each other with flat surfaces (for example, C-chamfer) or curved surfaces (for example, R-chamfer). In other words, the groove wall surface of the sipe 7 and the ground contact surface of the block 5 are adjacent, and a portion where the edge portions of the adjacent surfaces are connected with flat surfaces or curved surfaces is the chamfered portion 8.

The length Wm of the chamfered portion 8 in the tire width direction is less than 70% of the length Ws of the sipe 7 in the tire width direction. When the length Wm is less than 70% of the length Ws, block rigidity can be maintained to improve wear resistance performance as well as dry braking performance and wet braking performance. Note that, portions having lengths Ws1 and Ws2 in the length Ws of the sipe 7 in the tire width direction excluding the length Wm of the chamfered portion 8 in the tire width direction are provided with no chamfered portion 8 and with only the sipe 7.

The length Wm of the chamfered portion 8 in the tire width direction is 20% or more of the length Ws of the sipe 7 in the tire width direction. When the length Wm is 20% or more of the length Ws, block rigidity can be maintained to improve wear resistance performance as well as dry braking performance and wet braking performance. For example, when the length Ws of the sipe 7 in the tire width direction is 4 mm or more and 32 mm or less, the length Wm of the chamfered portion 8 in the tire width direction is 3 mm or more and 28 mm or less.

Note that the width of the circumferential main groove 2 in the direction perpendicular to its extension direction is, for example, 5 mm or more and 12 mm or less. The width of the chamfered portion 8 in the direction perpendicular to its extension direction is, for example, 1.0 mm or more and 3.0 mm or less.

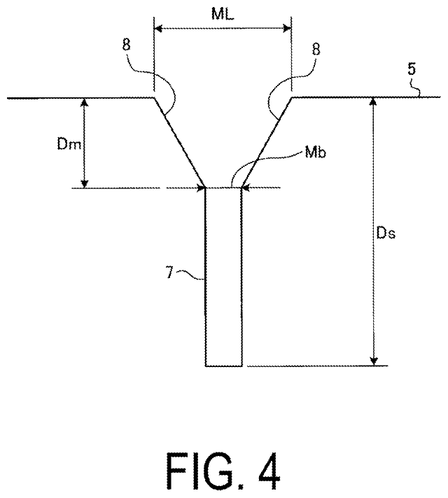

FIG. 4 is a cross-sectional view along line A-A in FIG. 3. In FIG. 4, when it is given that a depth of the sipe 7 is Ds, a depth (depth of the deepest portion) of the chamfered portion 8 is Dm, and a groove depth of the circumferential main groove is D, the relationship between the depths is D>Ds>Dm. With such a relationship in depth, block rigidity can be maintained to improve wear resistance performance as well as dry braking performance and wet braking performance.

The depth of the circumferential main groove 2 is, for example, 4 mm or more and 8 mm or less. The depth of the sipe 7 is, for example, 3 mm or more and 6 mm or less. The depth (depth of the deepest portion) of the chamfered portion 8 is, for example, 1 mm or more and 2 mm or less.

When a width of the chamfered portion 8 in the direction orthogonal to the extension direction of the sipe 7 on the road contact surface of the block 5 of the land portion 3 is ML, the relationship between the depth and the depth Dm of the chamfered portion 8 is ML>Dm. In other words, the width ML of the chamfered portion 8 becomes narrower toward a deepest portion Md. With such a relationship in depth, block rigidity can be maintained to improve dry braking performance and wet braking performance.

### Other Embodiments

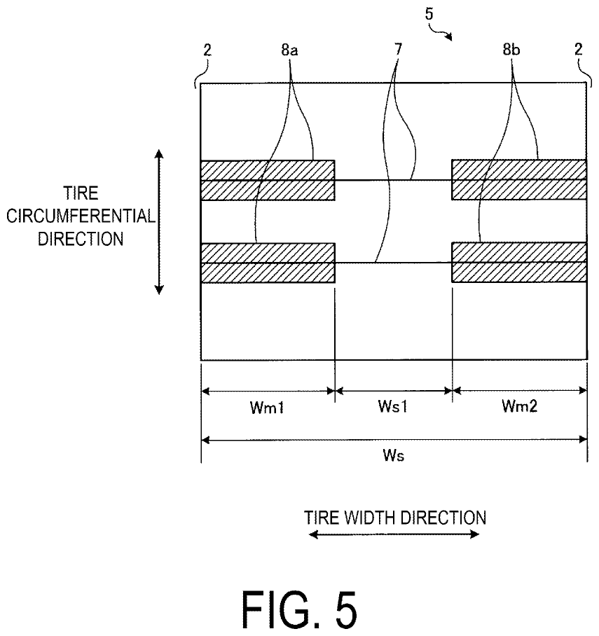

FIG. 5 is an enlarged view illustrating a second example of the block illustrated in FIG. 2. FIG. 5 is a plan view of one block 5 located in the center land portion 3C. In the present example, one sipe 7 is provided with two chamfered portions 8a, 8b. The chamfered portions 8a, 8b are connected to different circumferential main grooves 2.

A total length of a length Wm1 of the chamfered portion 8a in the tire width direction and a length Wm2 of the chamfered portion 8b in the tire width direction is less than 70% of the length Ws of the sipe 7. When the total length of the length Wm1 and the length Wm2 is less than 70% of the length Ws, block rigidity can be maintained to improve wear resistance performance as well as dry braking performance and wet braking performance. Note that, a portion having a length Ws1 in the length Ws of the sipe 7 in the tire width direction excluding the lengths Wm1 and Wm2 of the chamfered portion 8 in the tire width direction is provided with no chamfered portion 8 and with the sipe 7.

The total length of the length Wm1 and the length Wm2 is 20% or more of the length Ws of the sipe 7 in the tire width direction. When the total length of the length Wm1 and the length Wm2 is 20% or more of the length Ws, block rigidity can be maintained to improve wear resistance performance as well as dry braking performance and wet braking performance.

When it is given that a depth of the sipe 7 is Ds, a depth (depth of the deepest portion) of the chamfered portion 8d is Dm, and a groove depth of the circumferential main groove is D, the relationship between the depths is D>Ds>Dm. With such a relationship in depth, block rigidity can be maintained to improve wear resistance performance as well as dry braking performance and wet braking performance.

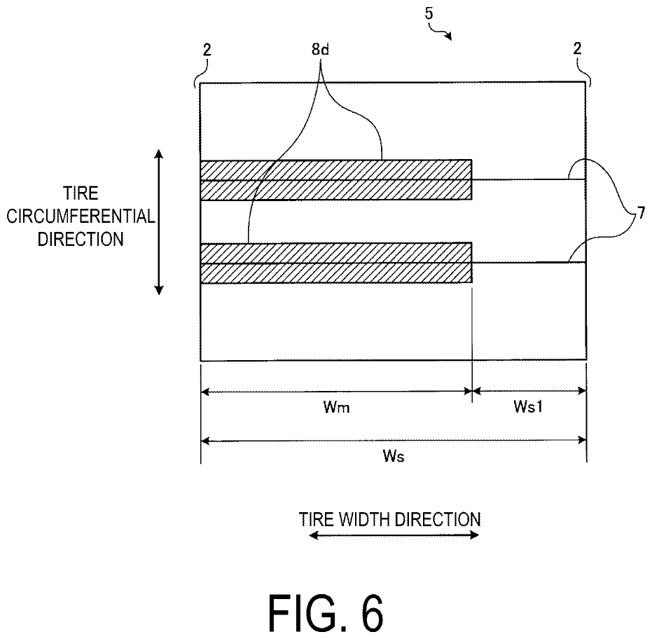

FIG. 6 is an enlarged view illustrating a third example of the block illustrated in FIG. 2. FIG. 6 is a plan view of one block 5 located in the center land portion 3C. In the present example, one sipe 7 is provided with one chamfered portion 8d. The chamfered portion 8d is connected to one circumferential main groove 2 in the tire width direction and is not connected to the other circumferential main groove 2.

The length Wm of the chamfered portion 8a in the tire width direction is less than 70% of the length Ws of the sipe 7. When the length Wm is less than 70% of the length Ws, block rigidity can be maintained to improve wear resistance performance as well as dry braking performance and wet braking performance. Note that, a portion having a length Ws1 in the length Ws of the sipe 7 in the tire width direction excluding the length Wm of the chamfered portion 8 in the tire width direction is provided with no chamfered portion 8 and with the sipe 7.

The length Wm of the chamfered portion 8 in the tire width direction is 20% or more of the length Ws of the sipe 7 in the tire width direction. When the length Wm is 20% or more of the length Ws, block rigidity can be maintained to improve wear resistance performance as well as dry braking performance and wet braking performance.

When a width of the chamfered portion 8 in the direction orthogonal to the extension direction of the sipe 7 on the road contact surface of the block 5 of the land portion 3 is ML, the relationship between the depth and the depth Dm of the chamfered portion 8 is ML>Dm. In other words, the width ML of the chamfered portion 8 becomes narrower toward a deepest portion Md. With such a relationship in depth, block rigidity can be maintained to improve wear resistance performance as well as dry braking performance and wet braking performance.

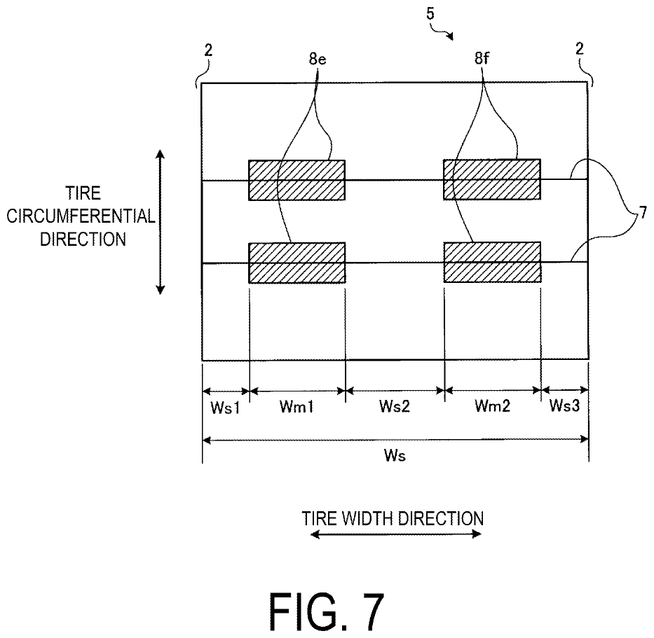

FIG. 7 is an enlarged view illustrating a fourth example of the block illustrated in FIG. 2. FIG. 7 is a plan view of one block 5 located in the center land portion 3C. In the present example, one sipe 7 is provided with two chamfered portions 8e, 8f. The chamfered portions 8e, 8f are not connected to the circumferential main groove 2.

A total length of a length Wm1 of the chamfered portion 8e in the tire width direction and a length Wm2 of the chamfered portion 8f in the tire width direction is less than 70% of the length Ws of the sipe 7. When the total length of the length Wm1 and the length Wm2 is less than 70% of the length Ws, block rigidity can be maintained to improve wear resistance performance as well as dry braking performance and wet braking performance. Note that, portions having lengths Ws1, Ws2, and Ws3 in the length Ws of the sipe 7 in the tire width direction excluding the lengths Wm1 and Wm2 of the chamfered portions 8e and 8f in the tire width direction are provided with no chamfered portion 8 and with the sipe 7.

The total length of the length Wm1 and the length Wm2 is 20% or more of the length Ws of the sipe 7 in the tire width direction. When the total length of the length Wm1 and the length Wm2 is 20% or more of the length Ws, block rigidity can be maintained to improve wear resistance performance as well as dry braking performance and wet braking performance.

When a width of the chamfered portion 8 in the direction orthogonal to the extension direction of the sipe 7 on the road contact surface of the block 5 of the land portion 3 is ML, the relationship between the depth and the depth Dm of the chamfered portion 8 is ML>Dm. In other words, the width ML of the chamfered portion 8 becomes narrower toward a deepest portion Md. With such a relationship in depth, block rigidity can be maintained to improve wear resistance performance as well as dry braking performance and wet braking performance.

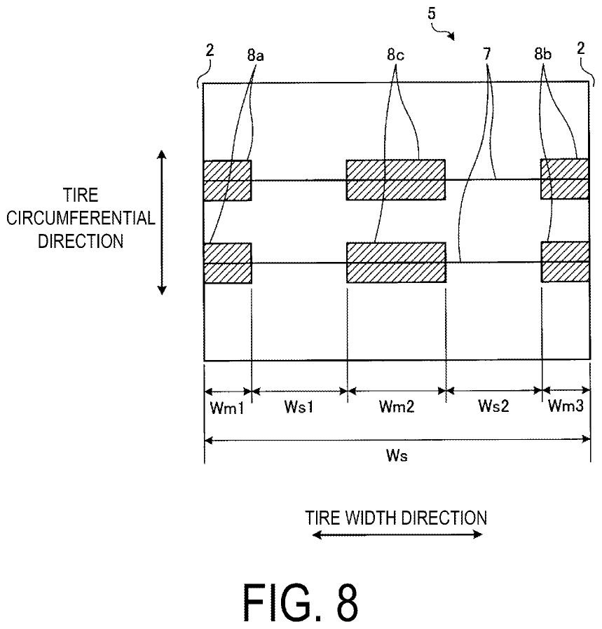

FIG. 8 is an enlarged view illustrating a fifth example of the block illustrated in FIG. 2. FIG. 8 is a plan view of one block 5 located in the center land portion 3C. In the present example, one sipe 7 is provided with three chamfered portions 8a, 8b, and 8c. The chamfered portions 8a, 8b are connected to different circumferential main grooves 2. The chamfered portion 8c is not connected to the circumferential main groove 2.

A total length of a length Wm1 of the chamfered portion 8a in the tire width direction, a length Wm2 of the chamfered portion 8b in the tire width direction, and a length Wm3 of the chamfered portion 8c in the tire width direction is less than 70% of the length Ws of the sipe 7. When the total length of the length Wm1, the length Wm2, and the length Wm3 is less than 70% of the length Ws, block rigidity can be maintained to improve wear resistance performance as well as dry braking performance and wet braking performance. Note that, portions having lengths Ws1 and Ws2 in the length Ws of the sipe 7 in the tire width direction excluding the lengths Wm1, Wm2, and Wm3 of the chamfered portions 8a, 8b, and 8c in the tire width direction are provided with no chamfered portion and with the sipe 7.

The total length of the lengths Wm1, Wm2, and Wm3 is 20% or more of the length Ws of the sipe 7 in the tire width direction. When the total length of the lengths Wm1, Wm2, and Wm3 is 20% or more of the length Ws, block rigidity can be maintained to improve wear resistance performance as well as dry braking performance and wet braking performance.

When a width of the chamfered portion 8 in the direction orthogonal to the extension direction of the sipe 7 on the road contact surface of the block 5 of the land portion 3 is ML, the relationship between the depth and the depth Dm of the chamfered portion 8 is ML>Dm. In other words, the width ML of the chamfered portion 8 becomes narrower toward a deepest portion Md. With such a relationship in depth, block rigidity can be maintained to improve wear resistance performance as well as dry braking performance and wet braking performance.

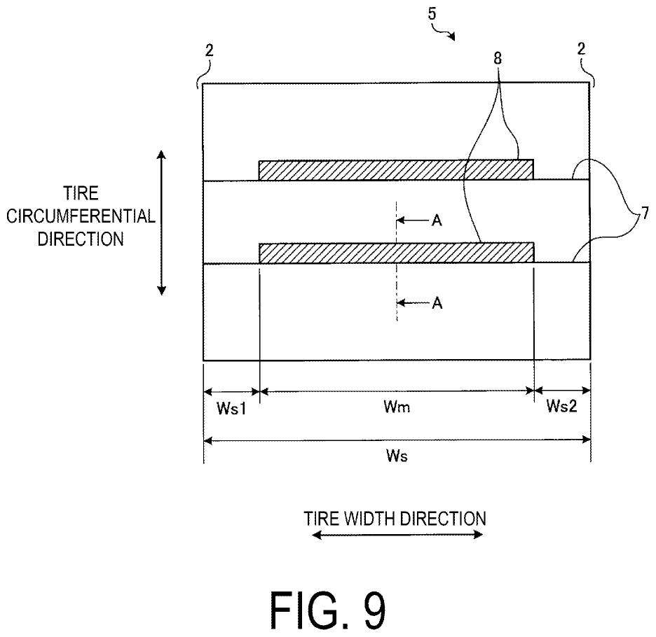

FIG. 9 is an enlarged view illustrating a sixth example of the block illustrated in FIG. 2. FIG. 9 is a plan view of one block 5 located in the center land portion 3C. In FIG. 9, one chamfered portion 8 is provided in the sipe 7 in the present example. In the present example, the chamfered portion 8 is provided only on one groove wall surface of the sipe 7. The chamfered portion 8 is not provided on the other groove wall surface of the sipe 7. In other words, the chamfered portion 8 is provided only on one of groove wall surfaces on both sides of the sipe 7. In the present example as well, the sipe 7 extends in the tire width direction through the block 5, which is the land portion. The length of the chamfered portion 8 provided in the sipe in the tire width direction is less than 70% of the length of the sipe 7 in the tire width direction. The length of the chamfered portions 8 in the tire width direction is 20% or more of the length of the sipe 7 in the tire width direction.

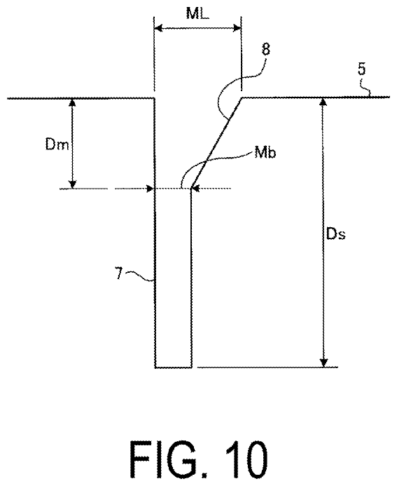

FIG. 10 is a cross-sectional view along line A-A in FIG. 9. In FIG. 10, when it is given that a depth of the sipe 7 is Ds, a depth (depth of the deepest portion) of the chamfered portion 8 is Dm, and a groove depth of the circumferential main groove is D, the relationship between the depths is D>Ds>Dm. With such a relationship in depth, block rigidity can be maintained to improve wear resistance performance as well as dry braking performance and wet braking performance.

As described with reference to FIGS. 9 and 10, by providing the chamfered portion 8 on at least one of the groove wall surfaces of the sipe 7, block rigidity can be maintained to improve wear resistance performance as well as dry braking performance and wet braking performance in the same manner as described with reference to FIGS. 3 and 4.

In FIGS. 3, and 5 to 9, the sipe 7 may be curved or bent (not illustrated). As illustrated in FIGS. 5, 7, and 8, in a case where a plurality of chamfered portions are provided in one sipe, some chamfered portions (not illustrated) may be provided on only one groove wall surface of the sipe 7.

### EXAMPLES

Table 1 is a table illustrating results of performance tests of pneumatic tires according to embodiments of the technology.

In the performance tests, for a plurality of types of test tires, wear resistance performance, dry braking performance, and wet braking performance were evaluated. The test tires having a size of 205/55R16 were assembled on wheels having a size of 16×6.5 J, and the tires were inflated to an air pressure of 200 kPa and mounted on a test FF sedan passenger vehicle (total engine displacement of 1600 cc).

Wear resistance performance was evaluated by measuring the distance traveled on the test vehicle on a dry road surface until the tread surface was fully worn, that is, the distance traveled until a wear indicator provided in the circumferential main groove 2 was exposed, and indexing the measured running distance. A larger index value indicates superior wear resistance performance. For dry braking performance, the braking distance was measured on a dry road surface at a speed of 100 km/h. Using the reciprocal of the measurement value, a larger index value indicates superior dry performance. For wet braking performance, the braking distance was measured on a wet road surface with a water depth of 1 mm at a speed of 100 km/h. Using the reciprocal of the measurement value, a larger index value indicates superior wet performance.

The pneumatic tires of Examples 1 to 9 are pneumatic tires provided with a circumferential main groove extending in the tire circumferential direction, a land portion defined by the circumferential main groove, a sipe extending through the land portion in the tire width direction, and a chamfered portion provided in the sipe. A length of the chamfered portion in the tire width direction is less than 70% of a length of the sipe in the tire width direction. Note that in all of the pneumatic tires of Examples 1 to 9, the relationship between the depth Ds of the sipe and the groove depth D of the circumferential main groove is D>Ds.

A pneumatic tire of Conventional Example is a pneumatic tire that has a sipe in a tread portion, but that does not have a chamfered portion at the sipe. A pneumatic tire of Comparative Example is a tire that has a sipe and a chamfered portion in the tread portion, and in which the length of the chamfered portion is 100% of the length of the sipe.

As illustrated in Table 1, in the case where the relationship between the depth Ds of the sipe and the depth Dm of the chamfered portion is Ds>Dm, and the relationship between the depth Dm of the chamfered portion is ML and the depth Dm of the chamfered portion is ML>Dm, excellent results for wear resistance performance, dry braking performance, and wet braking performance were obtained.

TABLE 1-1

| | Conventional | Comparative | | | |
|---|---|---|---|---|---|
| | Example | Example | Example 1 | Example 2 | Example 3 |
| Presence of sipe | Yes | Yes | Yes | Yes | Yes |
| Presence of | No | Yes | Yes | Yes | Yes |
| chamfered portion | | | | | |
| of sipe | | | | | |
| Length of | 0 | 100 | 68 | 65 | 60 |
| chamfered portion | | | | | |
| with respect to | | | | | |
| length of sipe (%) | | | | | |
| Relationship | — | — | Ds > Dm | Ds > Dm | Ds > Dm |
| between sipe depth | | | | | |
| Ds and chamfered | | | | | |
| portion depth Dm | | | | | |
| Relationship | — | — | ML < Dm | ML > Dm | ML > Dm |
| between chamfered | | | | | |
| portion width ML | | | | | |
| and chamfered | | | | | |
| portion depth Dm | | | | | |
| Wear resistance | 100 | 98 | 100 | 102 | 102 |
| performance | | | | | |
| Dry performance | 100 | 98 | 100 | 102 | 102 |
| Wet performance | 100 | 104 | 102 | 102 | 102 |

TABLE 1-2

| | Example 4 | Example 5 | Example 6 | Example 7 | Example 8 | Example 9 |
|---|---|---|---|---|---|---|
| Presence of sipe | Yes | Yes | Yes | Yes | Yes | Yes |
| Presence of chamfered | Yes | Yes | Yes | Yes | Yes | Yes |
| portion of sipe | | | | | | |
| Length of chamfered | 55 | 50 | 40 | 30 | 25 | 20 |
| portion with respect | | | | | | |
| to length of sipe (%) | | | | | | |
| Relationship between | Ds > Dm | Ds > Dm | Ds > Dm | Ds > Dm | Ds > Dm | Ds > Dm |
| sipe depth Ds and | | | | | | |
| chamfered portion | | | | | | |
| depth Dm | | | | | | |
| Relationship between | ML > Dm | ML > Dm | ML > Dm | ML > Dm | ML > Dm | ML > Dm |
| chamfered portion | | | | | | |
| width ML and | | | | | | |
| chamfered portion | | | | | | |
| depth Dm | | | | | | |
| Wear resistance | 102 | 103 | 103 | 103 | 104 | 104 |
| performance | | | | | | |
| Dry performance | 102 | 103 | 103 | 103 | 104 | 104 |
| Wet performance | 102 | 101 | 101 | 101 | 100 | 100 |

1. A pneumatic tire, comprising:
a circumferential main groove extending in a tire circumferential direction;
a land portion defined by the circumferential main groove;
a sipe extending through the land portion in a tire width direction; and
a chamfered portion provided in the sipe,
a length of the chamfered portion in the tire width direction being less than 70% of a length of the sipe in the tire width direction.

2. The pneumatic tire according to claim 1, wherein the length of the chamfered portion in the tire width direction is 20% or more of the length of the sipe in the tire width direction.

3. (canceled)

4. The pneumatic tire according to claim 3, wherein when a width of the chamfered portion in a direction orthogonal to an extension direction of the sipe in a road contact surface of the land portion is ML, a relationship between ML and the depth Dm of the chamfered portion is ML>Dm.

5. (canceled)

6. The pneumatic tire according to claim 2, wherein when a groove depth of the circumferential main groove is D, a depth of the sipe is Ds, and a depth of the chamfered portion is Dm, a relationship between depths is D>Ds>Dm.

7. The pneumatic tire according to claim 6, wherein when a width of the chamfered portion in a direction orthogonal to an extension direction of the sipe in a road contact surface of the land portion is ML, a relationship between ML and the depth Dm of the chamfered portion is ML>Dm.

8. The pneumatic tire according to claim 7, wherein the chamfered portion is provided on at least one of groove wall surfaces of the sipe.

9. The pneumatic tire according to claim 1, wherein when a groove depth of the circumferential main groove is D, a depth of the sipe is Ds, and a depth of the chamfered portion is Dm, a relationship between depths is D>Ds>Dm.

10. The pneumatic tire according to claim 1, wherein the chamfered portion is provided on at least one of groove wall surfaces of the sipe.
